(19) United States
(12) Patent Application Publication
(10) Pub. No.: US 2009/0091155 A1
(43) Pub. Date: Apr. 9, 2009

(54) Convertible Roof with Openable Rear Window

(75) Inventor: Stephen P. Rawlings, Onsted, MI (US)

Correspondence Address: BROOKS KUSHMAN P.C., 1000 TOWN CENTER, TWENTY-SECOND FLOOR, SOUTHFIELD, MI, 48075, US

(73) Assignee: MAGNA CAR TOP SYSTEMS GMBH, Rochester Hills, MI (US)

(21) Appl. No.: 12/246,687

(22) Filed: Oct. 7, 2008

Related U.S. Application Data
(60) Provisional application No. 60/978,345, filed on Oct. 8, 2007.

(51) Int. Cl. B60J 7/00

(52) U.S. Cl. 296/107.07

(57) ABSTRACT

A convertible top for a vehicle is disclosed that includes an inverted U-shaped rear window frame that defines an opening for a rear window. The rear window may be connected on its upper edge by a hinge to a rear window frame. Alternatively, a rear window may be retracted into a tailgate of a vehicle. The flexible cover material is secured to the rear window frame and a tailgate cooperates with the rear window and extends between the two lower ends of the rear window frame. The rear window is openable relative to the rear window frame.

### CROSS-REFERENCE TO RELATED APPLICATIONS

This application claims the benefit of U.S. Ser. No. 60/978,345 filed Oct. 8, 2007.

### BACKGROUND ART

1. Technical Field

The present invention relates to a soft-top convertible roof that has an openable rear window that may be pivoted on a hinge located at the upper edge of the window or retracted into a tailgate while in either version providing a fully retractable roof.

2. Brief Description of the Background Art

Vehicles such as conventional automobiles, sport utility vehicles, crossover vehicles, mini-vans and vans are popular with consumers because of their versatility. One way to increase the comfort, convenience and market for such vehicles is to provide a convertible roof. The term “convertible,” as used herein, refers to a roof having a flexible cover that may be opened to uncover the cabin of the vehicle.

Convertible roofs generally have a rear window, or back light, to provide visibility toward the rear of the vehicle. Some convertible roofs have a flexible rear window that folds with the convertible roof when the roof is stowed. Flexible rear windows may become scratch or discolored over time which reduces visibility. Other convertible roofs may have rigid rear windows, generally formed of glass, that require additional space and special roof architecture that does not require the rear window to bend as the convertible top s stowed. In either case, the rear window of a convertible top cannot be opened when the vehicle is in motion which limits ventilation when the top is extended. Also, access to the vehicle through the rear window opening is not possible when the vehicle is stopped because the rear window cannot be opened.

These and other problems are addressed by the convertible top that is disclosed and illustrated in this application as summarized below.

### SUMMARY OF THE INVENTION

According to one aspect of the invention, a convertible top for a vehicle is disclosed that comprises a top stack linkage including an inverted U-shaped rear window frame that at least partially defines an opening for a rear window that is selectively covered by the rear window. The rear window frame has first and second spaced sides that are connected on a pair of upper ends by a top member and have two spaced lower ends. A cover is supported by the top stack linkage and secured to the rear window frame. A tailgate is connected by a hinge to the vehicle and has an upper edge that extends between the two lower ends of the rear window frame. The rear window is pivotally connected to the rear window frame to enable the rear window to be opened relative to the U-shaped opening.

According to another aspect of the invention, a convertible top for a vehicle is disclosed that comprises a top stack linkage including a plurality of bows and a rear window frame that defines an inverted U-shaped opening that is selectively covered by a rear window. A flexible cover is supported by the top stack linkage. A tailgate is connected to the vehicle on a lower edge. The tailgate has an upper edge that extends between two lower ends of the rear window frame. A retractor is provided within the tailgate that shifts the rear window between a closed position in which the rear window covers the U-shaped opening and a retracted position in which the rear window is retracted into the tailgate to open the U-shaped opening.

Other features and aspects of the convertible top disclosed in this application will be readily understood by those of ordinary skill in the art in view of the attached drawings and the following detailed description of the disclosed embodiments.

### BRIEF DESCRIPTION OF THE DRAWINGS

FIG. 1 is a rear side perspective view of a convertible roof in its extended position that includes a rear window that is shown in both a lowered and a raised position;

FIG. 2 is a fragmentary rear perspective view showing a convertible top having a rear window that may be retracted into the tailgate for storage or extended by sliding into the convertible top;

FIG. 3 is a rear/side perspective view of a convertible having a top pivoted back light and a bottom pivoted tailgate;

FIG. 4 is a partial diagrammatic side elevation view of the embodiment of FIG. 3;

FIG. 5 is a rear/side perspective view of a convertible having a tailgate that pivots on its bottom edge and has a retractable rear window for retraction of the tailgate;

FIG. 6 is a partial diagrammatic side elevation view of the embodiment of FIG. 5;

FIG. 7 is a diagrammatic cross-section view showing a face seal and the cover attached to a rear window frame; and

FIG. 8 is a diagrammatic cross-section view of a captive window seal.

### DETAILED DESCRIPTION OF THE ILLUSTRATED EMBODIMENT(S)\

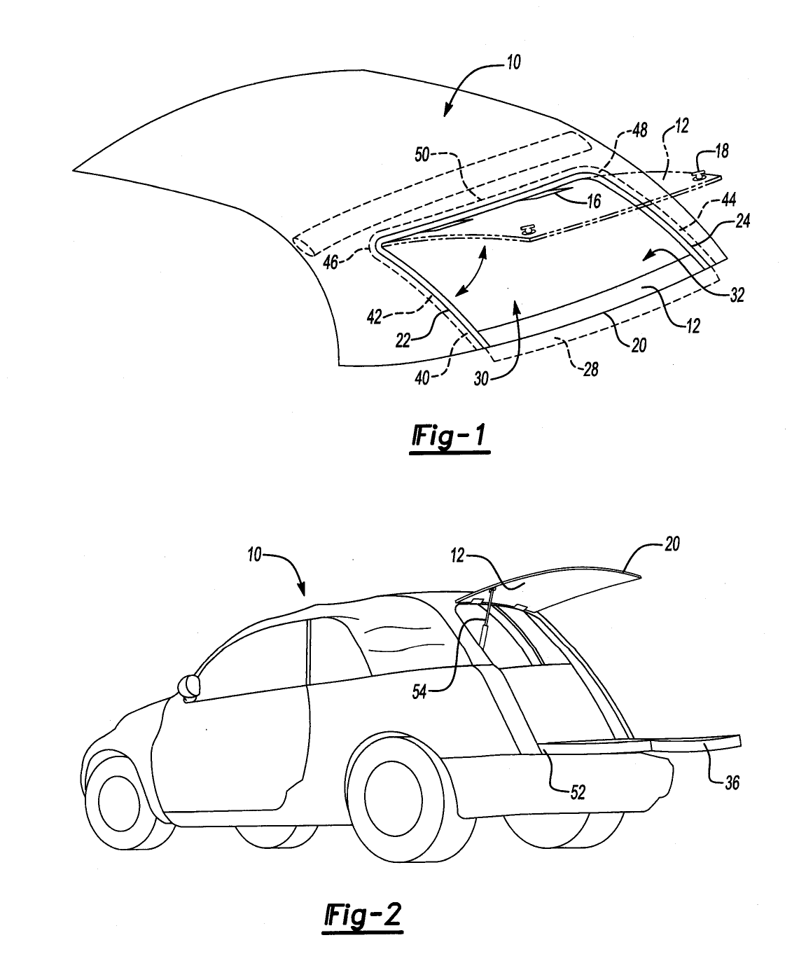

FIG. 1 shows a convertible top 10 having a rear window 12 that is pivotable on an upper edge on a hinge 16. Latches 18 are provided near the lower edge 20 of the window 12 on opposite first and second sides 22, 24 of the window 12 for securing the window to the convertible top 10. A belt line rail 28 is shown in phantom lines that may be provided to abut the lower end of the rear window. Access is possible through the rear window opening 30 to a box storage area 32 beneath the rear window 12. The open access may be provided if no rail 28 is provided at the base of the window and the tailgate 36 is open, or partial access may be provided above the rail 28 adjacent to the edge of the window. A rear window frame 40 is generally in an inverted U-shape and is formed by first and second side members 42, 44 that are connected on first and second upper ends 46, 48 to a top member 50. The first and second side members 42, 44 and top member 50 may be formed as separate parts or may be formed as a unitary structure. The first and second side members 42, 44 may be upwardly convergent and are preferably angled with the top member 50 being forward of the other parts of the rear window frame 40. The rear window 12 and opening 30 may be generally trapezoidal in shape.

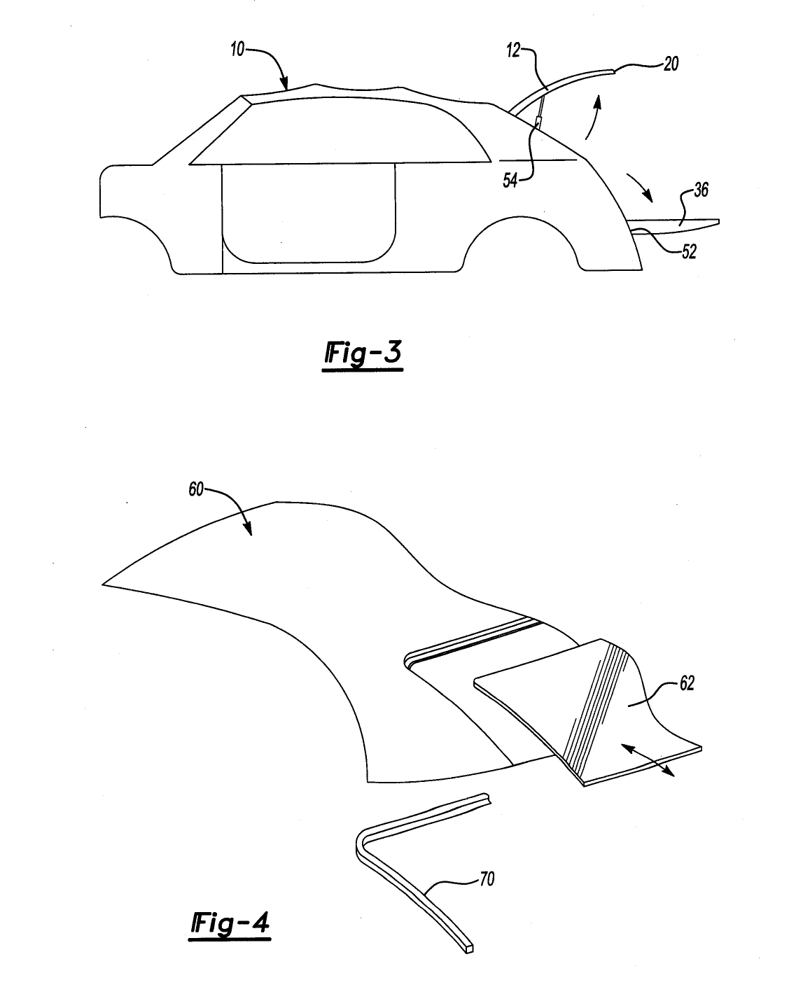

Referring to FIGS. 2 and 3, a convertible vehicle is shown that has a convertible top 10 for a vehicle that is like that shown in FIG. 1. The tailgate 36 pivots on its lower edge 52 and the rear window 12 pivots upwardly and is supported by an air spring 54 or other type of support to hold the rear window 12 in its raised position.

A package sensor (not shown) may be provided in the storage area 32. The package sensor may block top operation if a package is present in the storage area 32 or may also prevent operation of the convertible top 10 if the rear window 12 is open.

Referring to FIG. 4, an alternative embodiment of a convertible top 60 is partially shown with a rear window 62 diagrammatically indicated to be lowerable into a tailgate 64 located below the convertible top 60. The rear window 62 is retracted into the tailgate 64 before the tailgate 64 is pivoted open. The rear window 62 may be extended to cover the opening 66 in the convertible top 60 that is provided for the rear window. The rear window 62 may also be retracted into the tailgate 64 when the top 60 is in the extended position covering the passenger compartment.

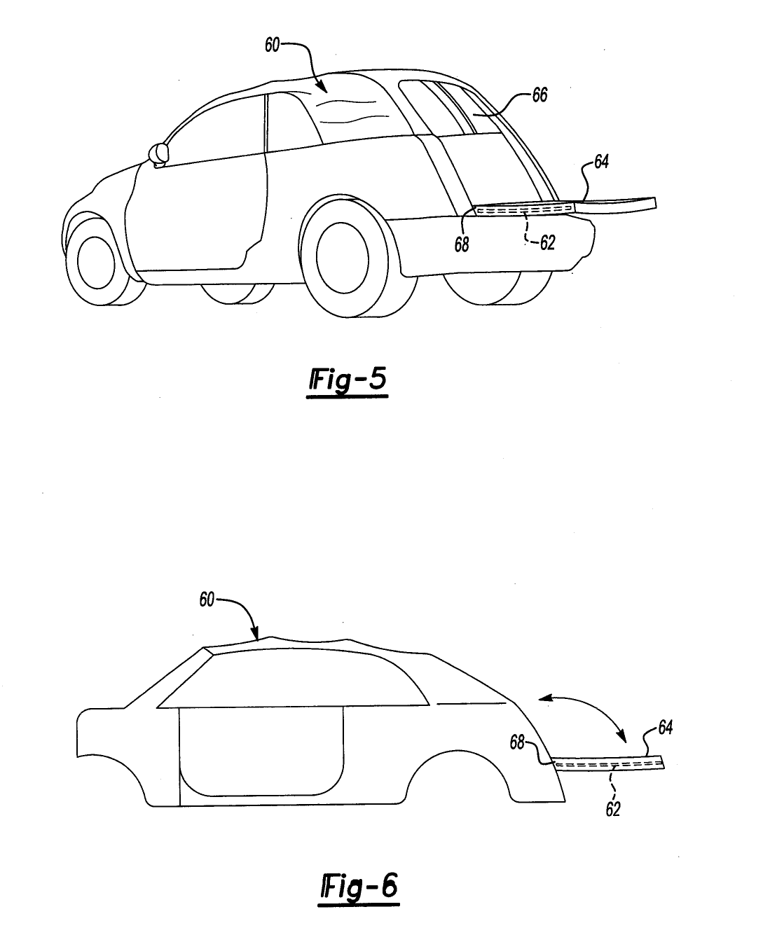

Referring to FIGS. 5 and 6, the tailgate 64 pivots on its lower edge 68 and also includes a retraction mechanism (not shown) that is a window retraction mechanism of conventional design for retracting the rear window 62 into the tailgate 64. The window 62 is retracted into the tailgate 64 before the tailgate 64 is pivoted open.

Referring to FIG. 4, a rear window frame 70 is provided that is similar in many respects to the rear window frame 40 described above. As shown, only half of the convertible top 60 is shown. It should be understood that a mirror image of the structure is provided on the opposite side of the vehicle. A side member 72 of the frame 70 is connected on an upper end 76 to a top member 80. The rear window frame 70, like the rear window frame 40 described above, provides a rigid frame that receives either rear window 12 or rear window 62 in a secure and sealed manner. The rear window frame 70 is either securely anchored to the vehicle or cross-braced within the convertible top stack structure to ensure a good fit between the rear windows and the rear window frames.

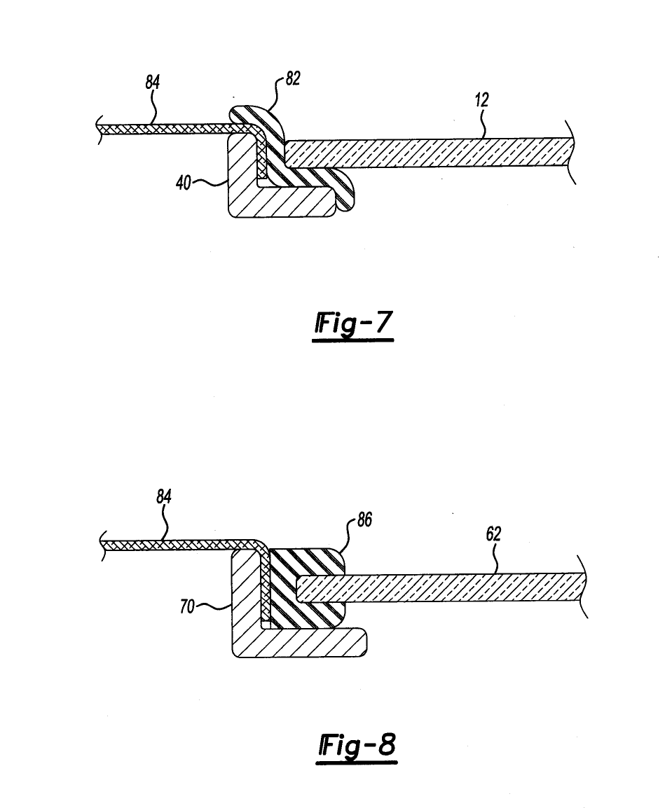

Referring to FIG. 7, a perimeter face seal 82 is shown that provides a seal between the rear window 12, 62 and the rear window frame 40, 70. A flexible cover 84 is secured to the rear window frame 40, 70. The flexible cover 84 may be secured by clips, a welt bead, fastening clamps or adhesive to the rear window frame 40, 70. The perimeter face seal 82 is the preferred type of seal for either the embodiment of FIGS. 1-3 or FIGS. 4-6.

As an alternative, referring to FIG. 8, an edge guide seal 86 could be provided that receives the rear window 62 of the embodiment of FIGS. 4-6. The edge seal guide 86 is provided on the rear window frame 70 and provides the seal between the rear window frame 70 and the rear window 62. The flexible cover 84 is intended to be secured to the rear window frame 70 as described above and is fixed in a permanent manner.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

I claim:

1. A convertible top for a vehicle comprising:
a top stack linkage including an inverted U-shaped rear window frame that at least partially defines an opening for a rear window, the rear window frame has first and second spaced sides that are connected on a pair of upper ends by a top member and have two spaced lower ends, wherein the opening is selectively covered by the rear window;
a cover supported by the top stack linkage and secured to the rear window frame;
a tailgate connected by a hinge to the vehicle, the tailgate having an upper edge that extends between the two lower ends of the rear window frame; and
wherein the rear window is pivotally connected to the rear window frame to enable the rear window to be opened relative to the rear window frame.

2. The convertible top of claim 1 wherein at least one hinge is provided between an upper portion of the rear window and the top member of the U-shaped frame.

3. The convertible top of claim 2 wherein the first and second sides of the window frame, the top member and upper edge of the tailgate form a generally trapezoidal shaped opening that is widest at the upper edge of the tailgate.

4. The convertible top of claim 1 wherein a tailgate seal is provided on the tailgate between the upper edge of the tailgate and a lower edge of the rear window to establish a sealed connection when the tailgate and the rear window are in a closed position.

5. The convertible top of claim 4 wherein a rear window frame seal is provided on the rear window frame to seal the rear window relative to the rear window frame.

6. A convertible top for a vehicle comprising:
a top stack linkage including a plurality of bows and a rear window frame that defines an inverted U-shaped opening that has two spaced lower ends, wherein the U-shaped opening is selectively covered by a rear window;
a cover supported by the top stack linkage;
a tailgate that is connected by a hinge to the vehicle on a lower edge, the tailgate having an upper edge that extends between the two lower ends of the rear window frame; and
a retractor provided in the tailgate that shifts the rear window between a closed position in which the rear window covers the U-shaped opening and a retracted position in which the rear window is retracted into the tailgate and opens the U-shaped opening.

7. The convertible top of claim 6 wherein the rear window is received within a slot that is provided within the U-shaped opening to establish a sealed connection between the rear window and the U-shaped opening.

8. The convertible top of claim 6 further comprising a sealing surface disposed on the rear window frame, and wherein the rear window has an upper edge and right and left side edges that engage the sealing surface.

9. The convertible top of claim 8 wherein the tailgate may be opened with the rear window in the retracted position.

10. The convertible top of claim 6 wherein the first and second sides of the window frame, the top member and upper edge of the tailgate form a generally trapezoidal shaped opening that is widest at the upper edge of the tailgate.
